(19) United States
(12) Patent Application Publication
(10) Pub. No.: US 2006/0050434 A1
(43) Pub. Date: Mar. 9, 2006

(54) Recording disk cartridge, and assembling method and assembling apparatus thereof

(76) Inventor: Kengo Oishi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 11/181,899

(22) Filed: Jul. 15, 2005

(30) Foreign Application Priority Data
Sep. 9, 2004 (JP) 2004-262411

(51) Int. Cl. G11B 23/03

(52) U.S. Cl. 360/133

(57) ABSTRACT

A recording disk cartridge of the present invention integrally rotatably houses center cores, where a plurality of flexible recording disk media are fixed, within a cartridge case through spacers, wherein the cartridge case has a lower plate for configuring a lower wall parallel to the recording disk media; at least one inner plate that is stacked and fixed on the lower plate, and partitions the plurality of the recording disk media; and an upper plate that is stacked and fixed on the inner plate, and configures an upper wall of the cartridge case, wherein in each of the center cores are formed stop holes, and in each of the spacers are formed stop protrusions that can fit in the stop holes of the center core and holding depressions having a constant positional relationship with the stop protrusions.

### BACKGROUND OF THE INVENTION

1. Field of the Invention

The present invention relates to a recording disk cartridge comprising a plurality of flexible recording disk media and an assembling method and assembling apparatus of the recording disk cartridge.

2. Description of the Related Art

Conventionally, as a magnetic disk medium a flexible recording disk medium is known where a magnetic layer is formed on both faces of a disc-form support body consisting of a flexible material such as a polyester sheet. Although the magnetic disk medium has a merit of speedily accessing data in comparison with a magnetic tape, on the other hand, it has a demerit of a memory capacity being small because a recording area thereof is small.

In order to solve the demerit of the flexible magnetic disk medium, it is conventionally disclosed a magnetic disk cartridge for housing a plurality of magnetic disk media in one cartridge case (for example, see JP 2004-22011A).

In this connection, because a flexible magnetic disk medium is low in rigidity thereof, there is a problem that the medium tends to vibrate in a vertical direction for a recording face if rotated. Therefore, in an invention of JP 2004-22011A each magnetic disk medium is made a configuration of being pinched by shutters. Thus by arranging plate members of high rigidity such as the shutters in a vicinity of the magnetic disk medium, the recording face can be stabilized because the medium becomes along the plate members, accompanied with a rotation of the medium.

However, because a magnetic disk cartridge of JP 2004-22011A is configured of movable shutters arranged by four for one magnetic disk medium, there is a problem that the cartridge is complicated in a structure thereof and is difficult to keep a parallelism to the medium. In addition, because the magnetic disk cartridge is mass produced goods, it is preferable to be excellent in assembling ability and productivity. Furthermore, the magnetic disk cartridge is preferable to be high in a degree of freedom in a design change so as to easily set a plurality of kinds thereof where number of magnetic disk media is made three, five, and the like.

From such a background are strongly requested a recording disk cartridge having a simple structure, excellent in assembling ability, and also easy in changing a number of recording disk media; and an assembling method and assembling apparatus of the recording disk cartridge.

### SUMMARY OF THE INVENTION

A recording disk cartridge of the present invention integrally rotatably houses center cores, where a plurality of flexible recording disk media are fixed, within a cartridge case through spacers, wherein the cartridge case comprises a lower plate for configuring a lower wall parallel to the recording disk media; at least one inner plate that is stacked and fixed on the lower plate, and partitions the plurality of the recording disk media; and an upper plate that is stacked and fixed on the inner plate, and configures an upper wall of the cartridge case, wherein in each of the center cores are formed stop holes, and in each of the spacers are formed stop protrusions that can fit in the stop holes of the center core, and holding depressions having a constant positional relationship with the stop protrusions.

In accordance with such the configuration, in the recording disk cartridge of the present invention the cartridge case is configured in a form of stacking up the lower plate, the inner plate, and the upper plate. Therefore, a pair of the inner plate and the recording disk medium can be made one unit, all inner plates can also be made a same part, and therefore, the recording disk cartridge is excellent in productivity. In addition, because a recording disk medium in an assembling process can also be carried by making a lower plate and an inner plate as a substitute of a tray, the recording disk cartridge is excellent also in assembling ability without damaging and staining the medium. In addition, in a case that it is intended to make a specification of changing a number of recording disk media, it is easy to change the specification because it suffices to mainly change a number of inner plates. Furthermore, because an inner plate of a partition plate is fixed as part of the cartridge case, the recording disk cartridge is easy to realize accuracy such as a parallelism to the recording disk media and can heighten a rotational stability especially at a high speed such as 2000 to 8000 rpm.

Furthermore, because in the spacer of the recording disk cartridge are formed the stop protrusions that can fit in the stop holes of the center core, and the holding depressions that have a constant relationship with the stop protrusions, it is enabled in an assembling process to easily position the spacer through the holding depressions. Accordingly, an assembling ability and productivity are improved.

In addition, in the recording disk cartridge, by dispensing an identification sign to the center core for indicating positions of stop holes thereof, it becomes easier to position the center core, and thus it is enabled to easily assemble the spacer and the center core. The identification sign is at least one of a notch, a depression, a protrusion, and a paint sign.

In addition, in stacking the center core where the recording disk media are fixed within the cartridge case, an assembling method of a recording disk cartridge of the present invention comprises the processes of detecting an identification sign of the center core, and placing the center core in a constant direction; and gripping holding depressions of the spacer by a chucker, positioning and fitting stop protrusions to/in stop holes of the center core placed. Therefore, while positioning both of the center core and the spacer with using the identification sign of the former and the holding depressions of the latter, it is enabled to stack the center core.

In addition, in stacking an upper center core on a lower center core the assembling method of the recording disk cartridge can more accurately position the center cores by comparing detection positions of two identification signs of the upper/lower center cores and compensating directions of the upper/lower center cores, based on the detection positions compared.

Furthermore, an assembling apparatus of a recording disk cartridge of the present invention comprises an identification sign detector for detecting an identification sign of the center core where the recording disk media are fixed; a center core chucker for placing the center core in a constant direction, based on the identification sign detected by the identification sign detector; a spacer chucker for gripping holding depressions of the spacer, and positioning and fitting the stop protrusions to/in stop holes of the center core placed by the center core chucker; and an assembling robot for assembling the cartridge case for housing the center core stacked by the center core chucker and the spacer chucker. Therefore, while positioning both of the center core and the spacer with using the identification sign of the former and the holding depressions of the latter, it is enabled to assemble the recording disk cartridge.

In addition, the assembling apparatus of the recording disk cartridge can more accurately position center cores by further comparing detection positions of two identification signs of the upper/lower center cores; and by comprising a spindle that rotates any of the upper/lower center cores and positions the upper center core, based on the detection positions compared.

### BRIEF DESCRIPTION OF THE DRAWINGS

FIG. 1 is an exploded perspective view of a magnetic disk cartridge related to an embodiment of the present invention.

FIG. 2A is a state of a shutter being closed of an appearance perspective view of a magnetic disk cartridge of an embodiment of the present invention; FIG. 2B is a state of the shutter being opened of an appearance perspective view of the magnetic disk cartridge.

FIG. 3 is a perspective view showing an inner face of an upper plate.

FIG. 4 is a section view taken along a line IV-IV in FIG. 2B of the magnetic disk cartridge loaded on a magnetic disk drive.

FIG. 5 is a partially enlarged drawing of FIG. 4.

FIG. 6 is an exploded perspective view showing a stack structure of magnetic disk media.

FIG. 7 is an illustration drawing showing a production process of the magnetic disk cartridge shown in FIG. 1.

FIG. 8 is a drawing showing a main part of a center core chucker used in a center core holding process shown in FIG. 7.

FIG. 9 is a drawing showing a main part of a spacer chucker used in a spacer holding process shown in FIG. 7.

FIG. 10 is a configuration drawing showing an assembling apparatus used in the production process shown in FIG. 7.

FIG. 11 is a process procedure showing a detail of an assembling process processed by the assembling apparatus shown in FIG. 10.

FIG. 12 is a drawing showing an assembly spindle for attracting a lower center core shown in FIG. 11 when it is placed.

FIG. 13 is a perspective view showing another configuration example of a spacer holding depression.

### DESCRIPTION OF THE PREFERRED EMBODIMENTS

[Recording Disk Cartridge]

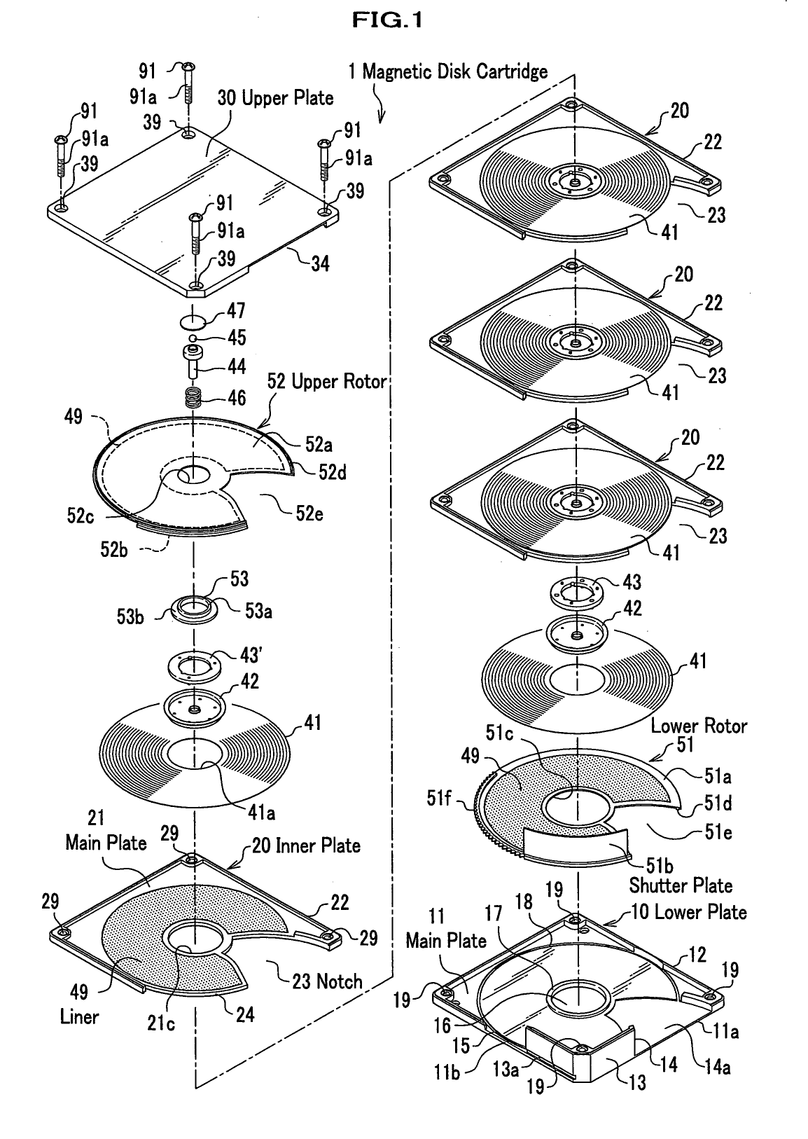

Firstly will be described a recording disk cartridge related to an embodiment of the present invention. Here will be described a case of a magnetic disk cartridge as an example, referring to FIGS. 1 to 6. Meanwhile, in a description below with respect to up/down directions, making it a standard a typical use state of the recording disk cartridge, vertical directions for faces of magnetic disk media are called the up/down directions for convenience.

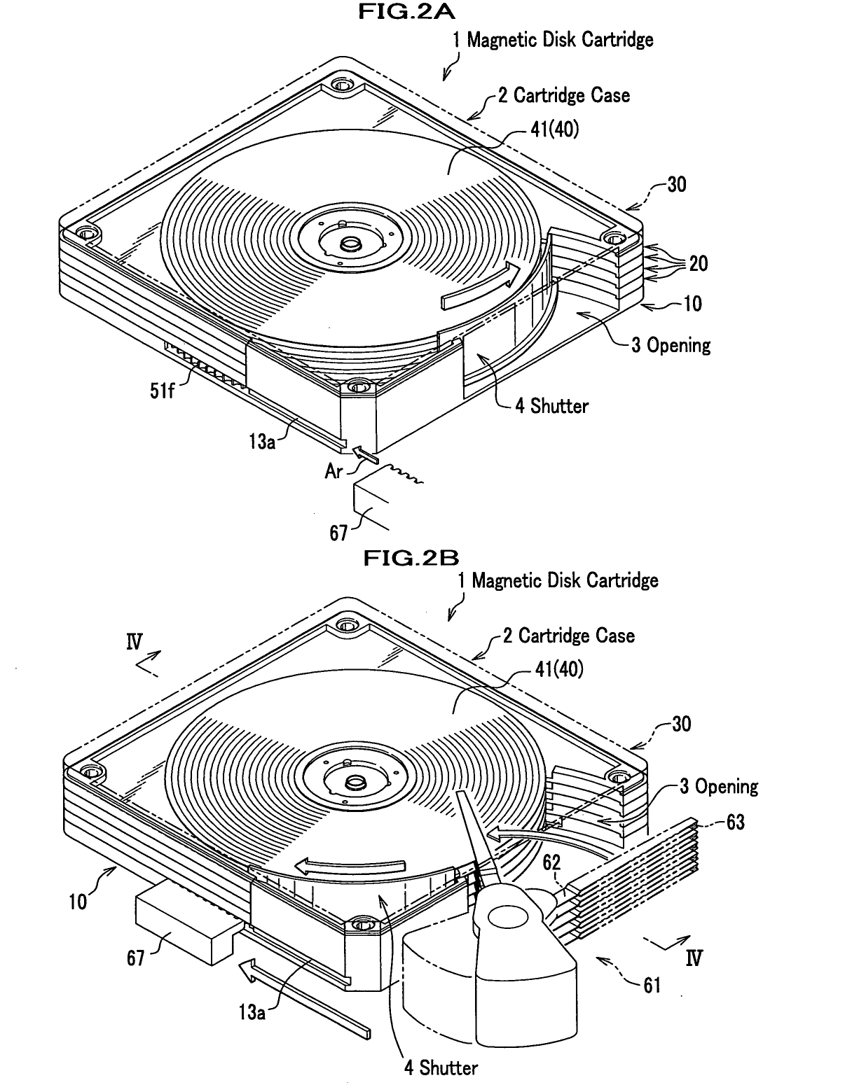

As shown in FIG. 1, in a magnetic disk cartridge 1 of an example of a recording disk cartridge are stacked a lower plate 10 for configuring a lower wall, a plurality of, for example, four inner plates 20, and an upper plate 30 for configuring a upper wall in this order; these are fastened and fixed with four screws 91; and thereby a cartridge case 2 (see FIG. 2A) is configured. In addition, between the lower plate 10 and the lowermost inner plate 20, between each of the four inner plates 20, and between the uppermost inner plate 20 and the upper plate 30 are arranged magnetic disk media 41, respectively. Each magnetic disk medium 41 is a disc form having an opening 41a at center thereof, and a center core 42 made of metal is affixed at rim of the opening 41a. In addition, it is designed that each of two center cores 42 is engaged by spacers 43, 43′, and that five magnetic disk media 41 (the magnetic disk media 41 stacked and integrated are assumed to be a disk stack 40) are integrally rotated.

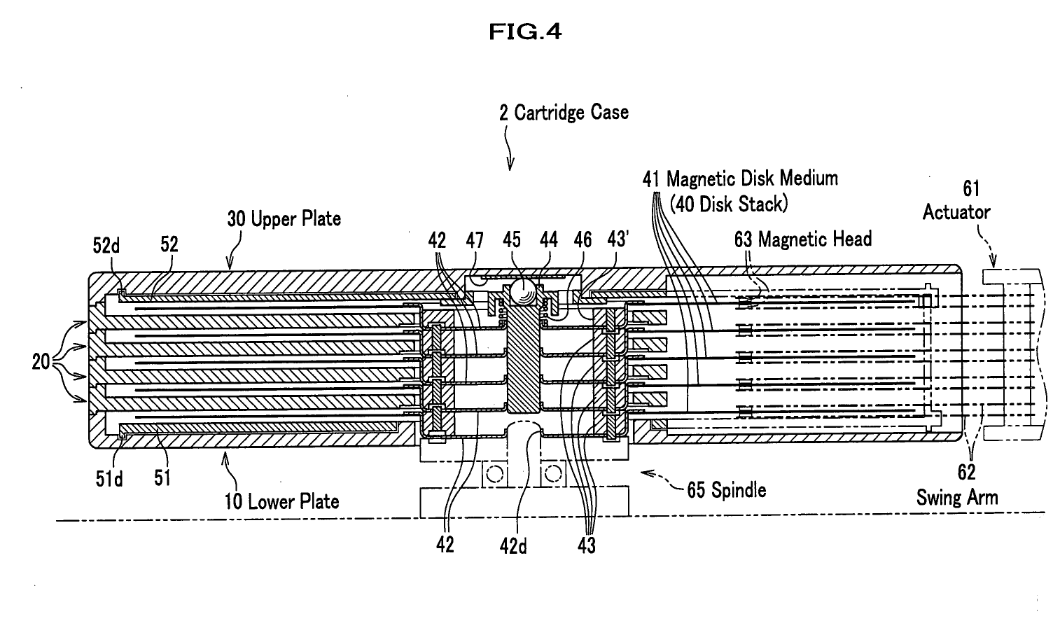

In each of the inner plates 20, at peripheral rim of a platy main plate 21 thereof is formed rib 22 abutting with upper/lower plates thereof. Part of a right near side of each of the inner plates 20 in FIG. 1 forms a notch 23 so that magnetic heads 63 (see FIG. 4) can easily move onto the magnetic disk media 41, respectively. At the portion of the notch 23 is not formed the rib 22, and therefore, if the inner plates 20 is stacked up, an opening 3 is formed on a side face of the cartridge case 2 as shown in FIG. 2A.

The opening 3 is opened/closed by a shutter 4 that coaxially rotates with the disk stack 40. As shown in FIG. 1, the shutter 4 is configured by combining a lower rotor 51 and an upper rotor 52.

Next will be described each member in more detail.

The lower plate 10 is designed at peripheral rim of a main plate 11 of a substantially square so as to mainly form a side wall 13, and a rib 12 for abutting with the rib 22 at a lower face of the lowermost inner plate 20. The side wall 13 is vertically provided in a predetermined range, for example, around one third range of one edge, from one corner of the main plate 11 (near side corner in FIG. 1), and is approximately formed in height of the inner plates 20 stacked.

It is designed that: a sector portion toward a center of the main plate 11 from one edge 11a (one edge of right near side in FIG. 1) continuing into the side wall 13 of the main plate 11 forms a depression 14a lowered by one step, does not form the rib 12 at peripheral rim of the main plate 11, and results in an opening 14. Thus it becomes easy for the magnetic heads 63 to proceed within the cartridge case 2.

An approximately central one third range of the other edge 11b (one side of left near side in FIG. 1) continuing into the side wall 13 of the main plate 11 is designed not to form the rib 12 and to result in an opening 15 so that a gear 51f of the lower rotor 51 described later can be exposed. In addition, outside the side wall 13 of the other edge 11b is formed a groove 13a along a periphery of the lower plate 10, continuing into the opening 15. The groove 13a is designed to be a passage where a shutter open gear 67 (see FIG. 2A) of a magnetic disk drive proceeds in a direction shown in an arrow mark Ar of FIG. 2A in order to engage in the gear 51f and enter in the opening 15.

The rib 12 is formed so as to protrude upward across all periphery except the side wall 13 and the openings 14,15 out of peripheral rim of the main plate 11. At center of the main plate 11 is formed a circular opening 16 for exposing the center core 42 provided inside the lowermost magnetic disk medium 41. At upper rim of the opening 16, across all periphery thereof is formed a rib 17 outside which a central opening 51c formed at center of the lower rotor 51 fits. The rib 17 rotationally freely supports the lower rotor 51.

In addition, on an upper face (inner face) of the main plate 11 is formed a circular lower rotor support groove 18 at a position corresponding to peripheral rim of the lower rotor 51. The lower rotor support groove 18 rotationally freely supports the lower rotor 51 coaxially with the magnetic disk media 41 by engaging in a rib 51d (see FIG. 4) formed downward at the peripheral rim of the lower rotor 51.

In addition, at four corners of the main plate 11 are formed screw holes 19 where female threads are formed, respectively, with penetrating through up/down directions.

The main plate 21 of each of the inner plates 20 is substantially a square, and a portion corresponding to one of four corners of the square is designed to be an arc (arc portion 24) one size larger than the magnetic disk medium 41. At one edge (right near side in FIG. 1) continuing into the arc portion 24 is formed the notch 23 into a sector. The rib 22 protrudes the up/down directions and is formed across all periphery except the arc portion 24 and the notch 23 out of periphery rim of the main plate 21. At center of the main plate 21 is formed a central opening 21c for enabling the upper center core 42 to be exposed and to be coupled with the lower center core 42.

In addition, at three corners of the main plate 21, with penetrating through the three corners in the up/down directions, are formed holes 29 through which screw shaft portions 91a of the screws 91 are inserted, respectively.

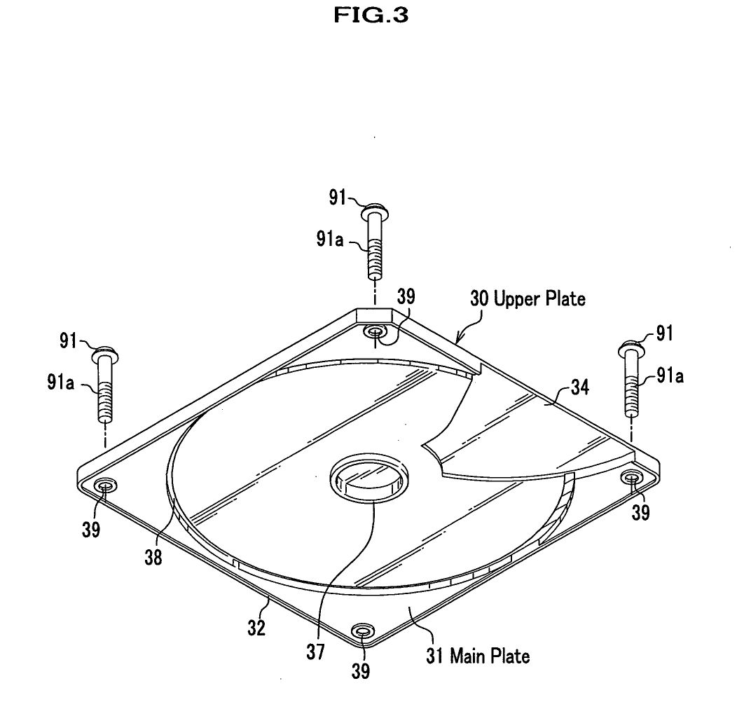

The upper plate 30 is formed substantially symmetric to the lower plate 10. As shown in FIG. 3, in the upper plate 30, on a substantially square main plate 31 are formed a depression 34 corresponding to the depression 14a, a rib 37 corresponding to the rib 17, and an upper rotor support groove 38 corresponding to the lower rotor support groove 18. Meanwhile, at center of the main plate 31 are not formed an opening and a side wall corresponding to the side wall 13.

In addition, at peripheral rim of the main plate 31, across all periphery except the depression 34 is formed a rib 32 protruding downward.

In addition, at four corners of the main plate 31 are respectively formed holes 39 that enables the screw shaft portions 91a of the screws 91 to be penetrated therethrough.

The lower rotor 51 is designed so that: a central opening 51c, a notch 51e, a rib 51d, and the gear 51f are formed on a ring-form lower rotor plate 51a substantially same as the magnetic disk media 41; and a shutter plate 51b is vertically provided at peripheral rim of the lower rotor plate 51a. The central opening 51c is formed as a circle fitting outside the rib 17, the notch 51e is formed as a sector corresponding to the depression 14a. In addition, the rib 51d is provided downward at peripheral rim of a lower face of the lower rotor plate 51a, corresponding to the lower rotor support groove 18.

The shutter plate 51b is a blocking member for blocking the opening 3 (see FIG. 2A) and the disk stack 40 and is vertically provided along the peripheral rim of the lower rotor plate 51a with neighboring the notch 51e. The gear 51f is an engaged portion for opening/closing the shutter 4 (see FIG. 2A) from outside of the magnetic disk cartridge 1, and is formed at the peripheral rim of the lower rotor plate 51a within a predetermined range with neighboring the shutter plate 51b.

The upper rotor 52 is designed to be substantially symmetric to the lower rotor 51: the upper rotor 52 comprises an upper rotor plate 52a similar to the lower rotor plate 51a; on the upper rotor plate 52a are formed a central opening 52c fitting outside the rib 37 of the upper plate 30, a notch 52e corresponding to the depression 34, and a rib 52d corresponding to the upper rotor support groove 38. In addition, at a portion adjacent to the notch 52e of peripheral rim of the upper rotor plate 52a is formed a shutter groove 52b, corresponding to the shutter plate 51b of the lower rotor 51. The lower rotor 51 and the upper rotor 52 are designed to integrally rotate by the shutter groove 52b and upper end rim of the shutter plate 51b engaging.

The upper rotor 52 is rotationally freely supported by the upper plate 30 by the central opening 52c fitting outside the rib 37 of the upper plate 30, and the rib 52d engaging in the upper rotor support groove 38. Meanwhile, the upper rotor 52 is prevented from dropping from the upper plate 30 by a stop member 53. The stop member 53 comprises a cylindrical portion 53a inserted in the rib 37 (see FIG. 3) and a flange 53b formed at one end of the cylindrical portion 53a; the cylindrical portion 53a is inserted in the central opening 52c from a lower side of the upper rotor 52 and is fixed at the rib 37 by ultrasonic welding, adhesion, and the like.

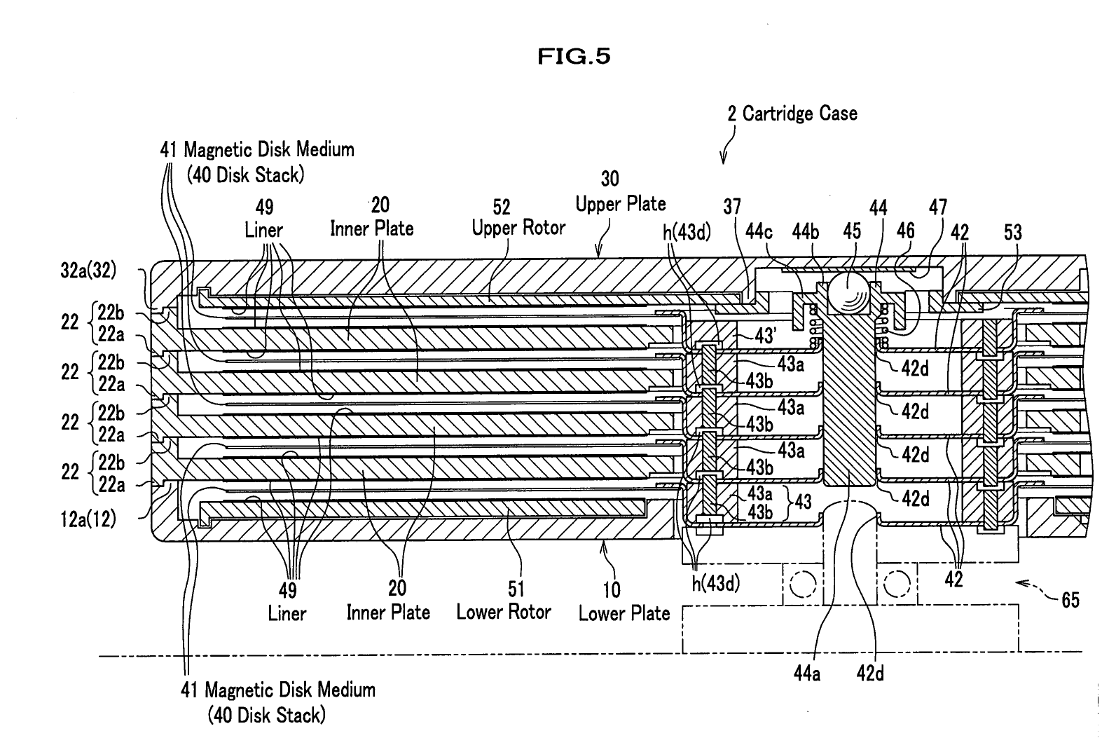

As an enlarged section drawing shown in FIG. 5, an upper face of the lower rotor 51, upper and lower faces of the inner plates 20, and a lower face of the upper rotor 52 are faces opposing the magnetic disk media 41, where liners 49 are affixed across portions opposing the media 41, respectively.

The liners 49 consist of, for example, a non-woven cloth such as a polyester fiber and a blended fabric fiber of rayon and polyester Next will be described a stack structure of the lower plate 10, the inner plates 20, and the upper plate 30.

In the rib 12 of the lower plate 10, as shown in FIG. 5, an inside thereof is formed higher by one step than an outside thereof, and thereby a male type step portion 12a is formed; each rib 22 of the inner plates 20 forms a female type step portion 22a protruding downward at outermost periphery, and thus a periphery of the male type step portion 12a and an inner perimeter of the female type step portion 22a become able to be fitted. In addition, when the lower plate 10, the inner plates 20, and the upper plate 30 are fastened by the screws 91 (see FIG. 1), an upper face of the male type step portion 12a and a corresponding portion of a lower face of the lowermost inner plate 20 are designed to be contacted. Thus, because the rib 12 of the lower plate 10 and the rib 22 of the inner plate 20 are sealingly abutted and fitted each other, an invasion of dust into the cartridge case 2 from outside is prevented.

Similarly, any adjacent two of the inner plates 20, and the uppermost inner plate 20 and the upper plate 30 are stacked by being sealingly abutted and fitted each other. In other words, on an upper face of each of the inner plates 20 is formed a male type step portion 22b where an inside of the upper face is formed higher by one step; at a rib 32 of the upper plate 30 is formed a female type step portion 32a of which outermost periphery protrudes downward by one step. And the male type step portion 22b of one inner plate 20 and the female type step portion 22a of an upper adjacent inner plate 20 are sealingly abutted and fitted each other; the male type step portion 22b of the uppermost inner plate 20 and the female type step portion 32a of the upper plate 30 are sealingly abutted and fitted, and stacked. Thus any adjacent two of the ribs 12, 22, 32 are sealingly abutted and fitted each other, and dust from outside is prevented from invading into the cartridge case 2. In addition, as soon as the lower plate 10, the inner plates 20, and the upper plate 30 are stacked, the side wall 13 of the cartridge case 2 is configured. Furthermore, because the lower plate 10, the inner plates 20, and the upper plate 30 are accurately positioned each other, and respective relative movements go away by being sealingly abutted and fitted each other, a rigidity of the cartridge case 2 improves.

In addition, both of the female type step portion 22a and the male type step portion 22b protrude higher than a thickness of the liner 49 from the main plate 21. Therefore, after affixing the liner 49 on the inner plate 20 and making an assembly, then even if placing it on a work bench, the liner 49 does not contact the work bench, and accordingly, and is not contaminated with dust and the like.

Such a configuration of the cartridge case 2 by stacking the inner plates 20 facilitates a change of a number of the magnetic disk media 41; although a height change of the side wall 13 and that of the shutter plate 51b are requested, a number of housing units of the magnetic disk media 41 formed within the cartridge case 2 can be changed only by mainly changing a number of the inner plates 20.

Next will be described the magnetic disk media 41 and a stack structure thereof. The magnetic disk media 41 are ones where magnetic paint is coated on both faces of a resin sheet, for example, such as polyester.

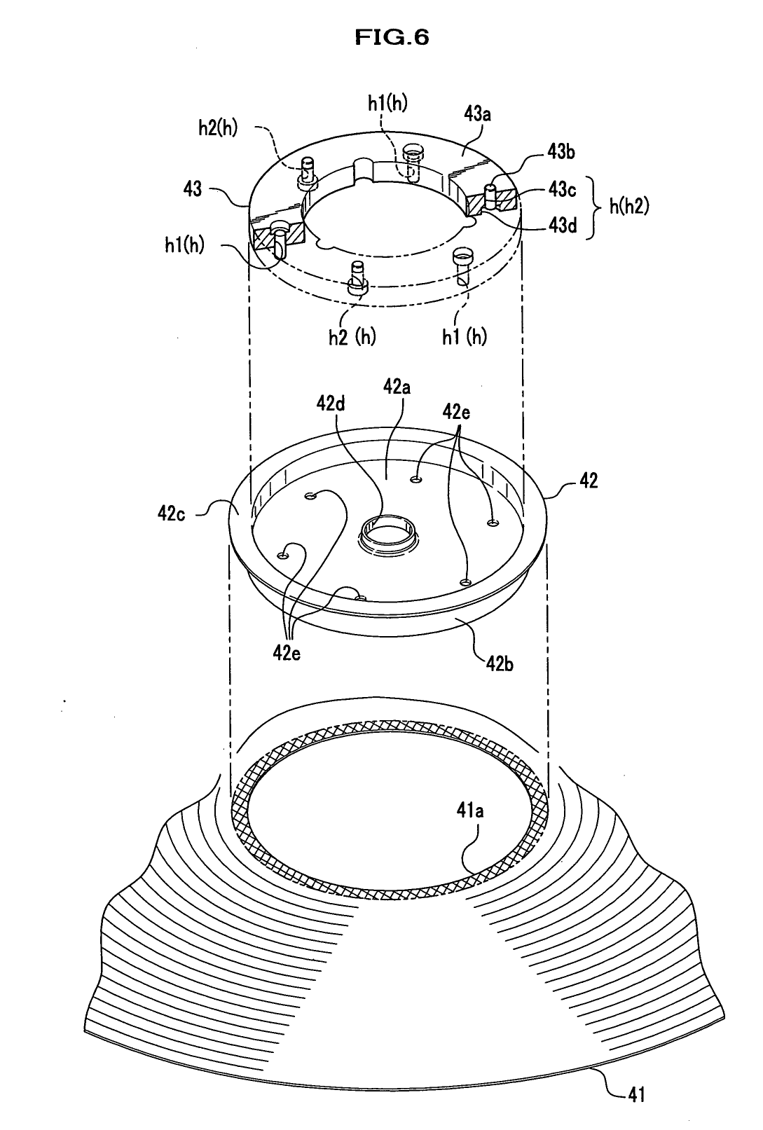

As shown in FIG. 6, each of the center cores 42 is one substantially made a hat form with draw forming a metal plate by press: the center core 42 is mainly configured of a circular bottom plate 42a, a low cylindrical side wall 42b rising from peripheral rim of the bottom plate 42a, and a flange 42c widening in an outer diameter direction from an upper end of the side wall 42b. At center of the bottom plate 42a is formed a center hole 42d, and at rim of the plate 42a are formed six small holes (stop holes) 42e at a distance of 60 degrees, making the center hole 42d a center thereof. In other words, the small holes 42e are arranged at a same distance on a same circle that makes it a center a rotation axis of the spacer 43 described later.

In addition, on the flange 42c positioned on an extension line connecting one of the small holes 42e and the center hole 42d is dispensed an identification sign 42f. The identification sign 42f is something for positioning the center core 42 in an assembling described later. Although here is assumed that a paint sign detectable by sensor is dispensed, a notch, a depression, and a protrusion mechanically detectable are also available. In addition, these may be combined.

A spacer 43 is provided between adjacent center cores 42, keeps a distance of each of the center cores 42, stops a rotation between each of the center cores 42, and functions so that the stacked magnetic disk media 41 integrally rotate. The spacer 43 is mainly configured of a main body portion 43a shaped like a ring from a resin, and metallic pins (stop protrusions) 43b pressed into the main body portion 43a.

In the main body portion 43a are formed six penetration holes h at positions corresponding to the small holes 42e of the center core 42, wherein each of the penetration holes h consists of a small diameter hole portion 43c, where the pin 43b is pressed, and a large diameter hole portion 43d that is coaxial with and slightly larger in diameter than small diameter hole portion 43c. The six penetration holes h are designed to be upside down in each two adjacent ones. In other words, penetration holes h2 of both adjacent penetration holes h1, where each the large diameter hole portion 43d is positioned at an upper side thereof, are arranged so that the large diameter hole portion 43d is positioned at a lower side thereof.

In addition, in the main body portion 43a are formed three holding depressions 43e having a constant positional relationship with the pins 43. The constant positional relationship means a relative positional relationship: here each of the holding depressions 43e is formed at a midway point between one pin 43 protruded downward and another pin 43 protruded upward, and thus the constant positional relationship is kept.

Into each of the small diameter portions 43c is pressed each one pin 43b from upper/lower sides thereof, one end of the pin 43b is positioned at a boundary of the large diameter hole portion 43d and the small diameter hole portion 43c, and the other end thereof protrudes outside the small diameter portion 43c. The large diameter hole portion 43d serves a function of a clearance at a top end of another pin 43b of an adjacent spacer 43.

As shown in FIG. 5, such the spacers 43 are provided between adjacent center cores 42, respectively. One pin 43b protruding toward a lower side of each of the spacers 43 enters in a small hole 42e of one center core 42 at the lower side of the spacer 43, and stops a relative rotation to the center core 42 at the lower side. If there is another spacer 43 at a still lower side than the center core 42 at the lower side, a floating-up of the spacer 43 for the center core 42 is prevented by the pin 43b entering the large diameter hole portion 43d in the spacer 43 at the lower side. The other pin 43b protruding toward an upper side of the spacer 43 enters in a small hole 42e of the other center core 42 at the upper side of the spacer 43, and stops a relative rotation to the center core 42 at the upper side. If there is another spacer 43 at a still upper side than the center core 42 at the upper side, the top end of the pin 43b enters in the large diameter hole portion 43d in the spacer 43 at the upper side.

Meanwhile, because at an upper side the uppermost center core 42 has no center core 42 to stop a rotation thereof, at the upper side is arranged a thin top spacer 43′ in thickness where the pin 43b is protruded only downward.

Thus the pins 43b of the spacers 43, 43′ and the small holes 42e of the center cores 42 are fitted in a depression and protrusion, and the spacers 43, 43′ are attached to the center cores 42; thereby the spacers 43, 43′ and the center cores 42 are engaged, and a plurality of center cores 42 are integrally configured.

The magnetic disk media 41 thus stacked, namely, the disk stack 40, are stably supported in rotation by a coupling shaft 44, a bearing ball 45, a compression coil spring 46, and a center plate 47.

As shown in FIG. 5, the coupling shaft 44 lessens a central fluctuation between the center cores 42 stacked, holds the bearing ball 45 and the compression coil spring 46, and comprises a shaft portion 44a, a ball holding portion 44b, and a spring holding portion 44c. The shaft portion 44a is a columnar form that can be inserted through the center holes 42d of the center cores 42. At an upper end of the shaft portion 44a the ball holding portion 44b is formed into a cylindrical form with a bottom opening to an upper side thereof. A depth of the ball holding portion 44b is larger than a radius of the bearing ball 45, and therefore, the bearing ball 45 is stably held at the ball holding portion 44b. The spring holding portion 44c consists of a form where a cylindrical form with a bottom is turned down at a side of an outer diameter of the ball holding portion 44b, and the compression coil spring 46 is arranged in a cylindrical space between the shaft portion 44a and the spring holding portion 44c. Meanwhile, although a length of the coupling shaft 44 is arbitrary, in the embodiment it is one reaching the second center core 42 from the lowermost one; the center hole 42d of the lowermost center core 42 is opened so that a spindle 65 of a magnetic disk drive can proceed.

The center plate 47 is a slide member affixed at the center of an inner face of the upper plate 30, that is, on a flat face of an inside of the rib 37. The center plate 47 can be composed of, for example, a material excellent in sliding ability and abrasion resistance such as polyoxymethylene and ultra high molecular weight polyethylene.

Although the bearing ball 45 consists of a sphere made of, for example, steel used for a ball bearing, it may also be composed of a material excellent in sliding ability and abrasion resistance, for example, such as polytetrafluoroethylene and polyoxymethylene. The bearing ball 45 is arranged within the ball holding portion 44b of the coupling shaft 44, abuts with the bottom face of the ball holding portion 44b; and a center of an inner face of the upper plate 30, that is, the center plate 47 by a point contact, and rotationally supports the disk stack 40.

In the compression coil spring 46 one end (upper end) is held by the spring holding portion 44c of the coupling shaft 44; the other end (lower end) abuts with an upper face of the uppermost center core 42, and energizes the stacked center cores 42 to the side of the lower plate 10, that is, to the side of the spindle 65 of the magnetic disk drive. Thus the center cores 42 do not jounce within the cartridge case 2, and the fluctuation of the magnetic disk media 41 is prevented in rotation thereof.

A magnetic disk drive for recoding/reproducing data for the magnetic disk cartridge 1 rotates, as shown in FIG. 4, the disk stack 40 by the spindle 65. The spindle 65 attracts the lowermost center core 42 by magnetic force, enters in the center hole 42d of the center core 42, and thereby matches an axis thereof with that of the disk stack 40. At this time, because the spindle 65 slightly lifts up the center cores 42 with resisting an energizing force of the compression coil spring 46, as shown in FIGS. 4 and 5, each of the magnetic disk media 41 is positioned at center of a space formed between the lower rotor 51 and the lowermost inner plate 20, between upper and lower inner plates 20, and between the uppermost inner plate 20 and the upper rotor 52. The magnetic heads 63 are provided at top ends of swing arms 62. Each of the magnetic heads 63 is arranged on both faces of each of the magnetic disk media 41.

The magnetic disk cartridge 1 thus described can prevent, in no use thereof as shown in FIG. 2A, an invasion of dust thereto by closing the opening 3 with rotating the shutter 4 in a counterclockwise direction of the drawing; in use thereof as shown in FIG. 2B, when loaded on the magnetic disk drive, the shutter open gear 67 fits in the groove 13a, is guided thereby, engages in the gear 51f, and rotates the shutter 4 in a clockwise direction of the drawing.

In addition, the disk stack 40 rotates by the spindle 65 rotating. After then, the swing arms 62 rotate by being driven with an actuator 61, and each of the magnetic heads 63 are moved onto each face of the magnetic disk media 41.

When recording data on the magnetic disk media 41 with the magnetic heads 63, the data is recorded thereon by sending a signal to the magnetic heads 63 by a control circuit not shown; when reproducing data from the magnetic disk medium 41, a signal is output by detecting a change of a magnetic field on the medium 41 with the magnetic heads 63a.

At this time, dust on the magnetic disk media 41 is removed by the liners 49 appropriately touching respective media 41.

After the use of the magnetic disk cartridge 1, the magnetic heads 63 are retracted from the cartridge case 2, thereafter ejects the magnetic disk cartridge 1; thereby the gear 51f is driven by the shutter open gear 67, and the shutter 4 closes the opening 3.

Thus because the magnetic disk cartridge 1 has a plurality of the magnetic disk media 41, data transfer can be performed at a higher speed by simultaneously accessing data with a plurality of magnetic heads 63.

In addition, because the cartridge case 2 is configured by stacking up the inner plates 20, it is easy to perform a specification change of making a number of magnetic disk media 41 a different one. Then, in assembling the magnetic disk cartridge 1, because the magnetic disk media 41 can be handled with being placed on the inner plates 20 and the lower rotor 51 built in the lower plate 10, an occasion of touching the magnetic disk media 41 can be reduced and a quality of the cartridge 1 can be further stablized.

In addition, because each of the inner plates 20 is stacked on the lower plate 10 or another inner plate 20 and is fixed, the magnetic disk cartridge 1 can make it higher a parallelism to the magnetic disk media 41, can stabilize a rotation of the media 41, and enable a higher speed rotation of the media 41, furthermore a higher speed of a data transfer.

[Production Process of Magnetic Disk Cartridge]

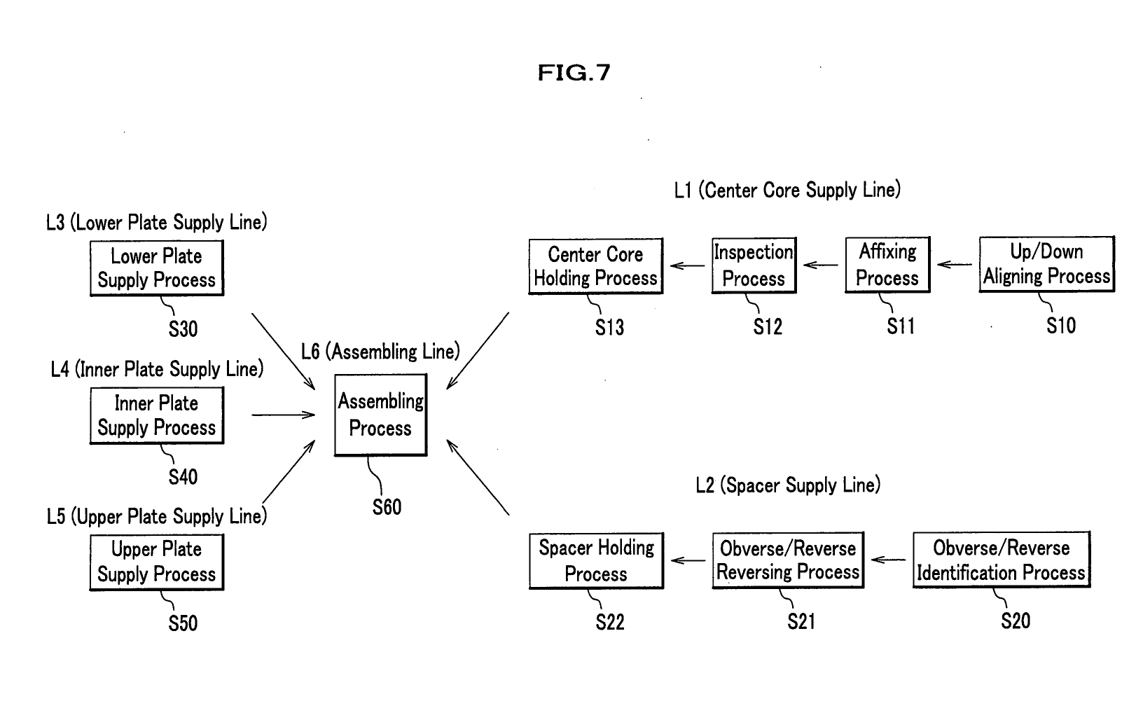

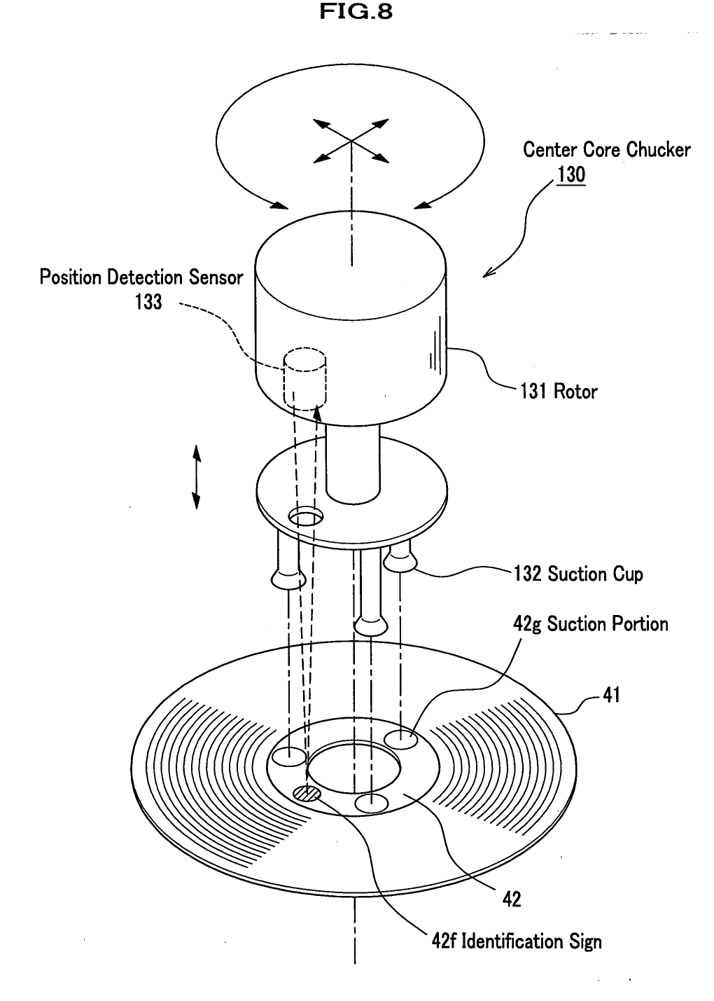

Next will be described a production process of the magnetic disk cartridge 1. As shown in FIG. 7, the production process of the magnetic disk cartridge 1 comprises a center core supply line L1, a spacer supply line L2, a lower plate supply line L3, an inner plate supply line L4, an upper plate supply line L5, and an assembling line L6. Describing these in detail, the center core supply line L1 is a line for supplying the center core 42, where the magnetic disk media are affixed, to the assembling line L6, and comprises four processes of an up/down-directions aligning process S10, an affixing process S11, an inspection process S12, and a center core holding process S13. Firstly, in the up/down-directions aligning process S10 upper/lower faces of the center core 42, obverse and reverse, are aligned in a constant direction: here by using an alignment supply apparatus comprising a parts feeder function. Subsequently, in the affixing process S11 the magnetic disk media 41 are affixed to the center core 42 directed in the constant direction in the up/down-directions aligning process S10: for example, by inserting a guide pin in the center hole 42d. Then in the inspection process S12 is performed a defect inspection of the magnetic disk media 41 affixed in the affixing process S11; in the center core holding process S13 is held the center core 42 where the magnetic disk media 41, which has passed the inspection in the inspection process S12, are affixed. The holding is performed with using a center core chucker 130 shown in FIG. 8, and will be described in detail below.

The center core chucker 130 shown in FIG. 8 is designed to be movable up/down, and to comprise a rotor 131 rotatable left/right, suction cups 132 of the center core 42, and a position detection sensor (position detection unit) 133 of the identification sign 42f of the center core 42 shown in FIG. 6. The position detection sensor 133 is a photosensor and is designed to detect the identification sign 42f of the center core 42. Thus designed, the center core chucker 130 holds suction portions 42g of the center core 42 with the suction cups 132 while moving up/down and rotating so as to make positions of the small holes 42e, which are in a constant positional relationship with the identification sign 42f, those set in advance, based on a position of the identification sign 42f detected by the position detection sensor 133. Thus it is enabled to position the center core 42.

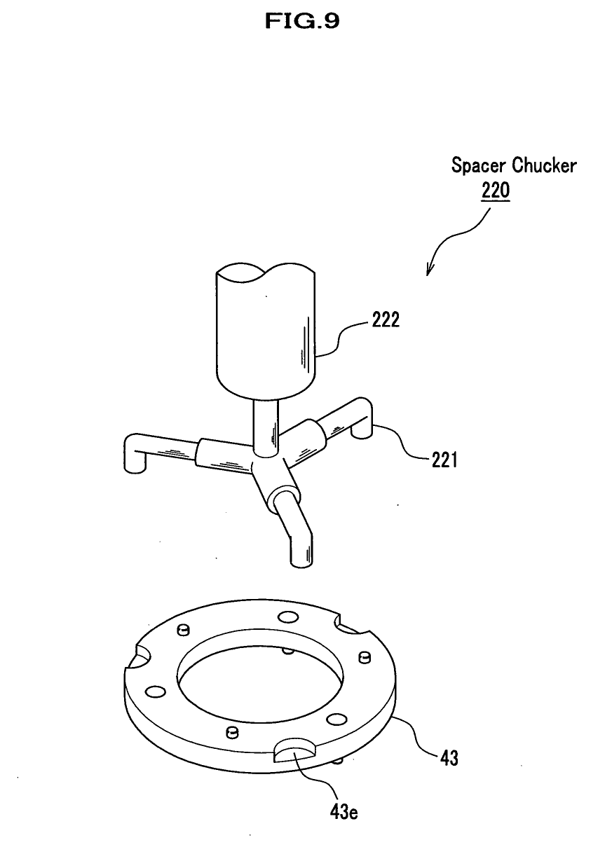

Returning to FIG. 7, the spacer supply line L2 is a line for supplying the spacer 43 (inclusive of the spacer 43′, hereinafter same) to the assembling line L6, and comprises three processes of an obverse/reverse identification process S20, an obverse/reverse reversing process S21, and a spacer holding process S22. Firstly, in the obverse/reverse identification process S20 is identified the obverse/reverse of the spacer 43. The identification is, for example, performed by detecting a difference of reflection lights of both faces of reverse/obverse of the spacer 43. Subsequently, in the obverse/reverse reversing process S21 a face of the spacer 43 identified as the reverse in the obverse/reverse identification process S20 is reversed and made the obverse, for example, by a reversing gear. Then in the spacer holding process S22 is held the spacer 43 aligned to the obverse in the obverse/reverse reversing process S21. The holding is performed by using a spacer chucker 220 shown in FIG. 9, and will be described in detail below.

The spacer chucker 220 shown in FIG. 9 is designed to be rotatable and movable up/down, and to comprise grippers 221 of the spacer 43 and a position detection sensor 222 of the holding depressions 43e of the spacer 43 shown in FIG. 6. Thus designed, the spacer chucker 220 holds the holding depressions 43e of the spacer 43 by the grippers 221. Then the spacer chucker 220 adjusts the spacer 43 so that a direction of the spacer 43 becomes one set in advance, based on a detection signal from the position detection sensor 222. Thus it is enabled to position the spacer 43.

Returning to FIG. 7, the lower plate supply line L3 is a line for supplying the lower plate 10 to the assembling line L6, and is designed to comprise a lower plate supply process S30. In the lower plate supply process 30 is supplied the lower plate 10 in a state of the lower rotor 51, the shutter plate 51d, and the liner 49 shown in FIG. 1 being loaded.

In addition, the inner plate supply line L4 is a line for supplying the inner plate 20 to the assembling line L6, and is designed to comprise an inner plate supply process S40. Furthermore, the upper plate supply line L5 is a line for supplying the upper plate 30 to the assembling line L6, and is designed to comprise an upper plate supply process S50. In these supply processes S30, S40, and S50 is used, for example, a carrier.

The assembling line L6 is a line for assembling in predetermined order the center core 42, the spacer 43, the lower plate 10, the inner plate 20, and the upper plate 30 supplied from the lines L1 to L5, respectively, and is designed to comprise an assembling process S60. In the assembling process S60 are used an assembling robot 600, an assembling spindle 601, and the like, and they will be described in detail later.

[Assembling Apparatus of Magnetic Disk Cartridge]

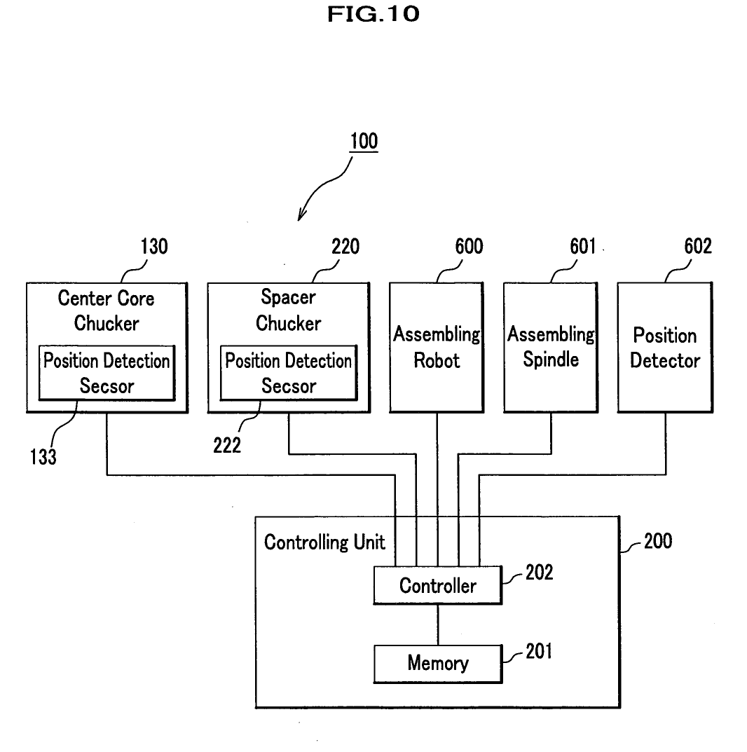

Next will be described a configuration of an assembling apparatus 100 for automatically performing a production process shown in FIG. 7, based on FIG. 10.

In FIG. 10 the assembling apparatus 100 comprises the center core chucker 130 shown in FIG. 8, the spacer chucker 220 shown in FIG. 9, the assembling robot 600, the assembling spindle 601, the position detector 602, and a controlling unit 200 for driving and controlling these. The controlling unit 200 comprises a memory 201 and a controller 202.

The assembling robot 600 is designed to assemble the lower plate 10 supplied from the lower plate supply process S30, the inner plate 20 supplied from the inner plate supply process S40, and the upper plate 30 supplied from the upper plate supply process S50 shown in FIG. 7, using a robot hand and the like.

The assembling spindle 601 positions the center core 42 in the assembling process S60 shown in FIG. 7.

The position detector 602 is, for example, a photo sensor, and is designed to detect the identification sign 42f of the center core 42 in the assembling process S60 shown in FIG. 7. Meanwhile, in FIG. 10 a configuration of the known assembling apparatus 100 such as a carrier is omitted.

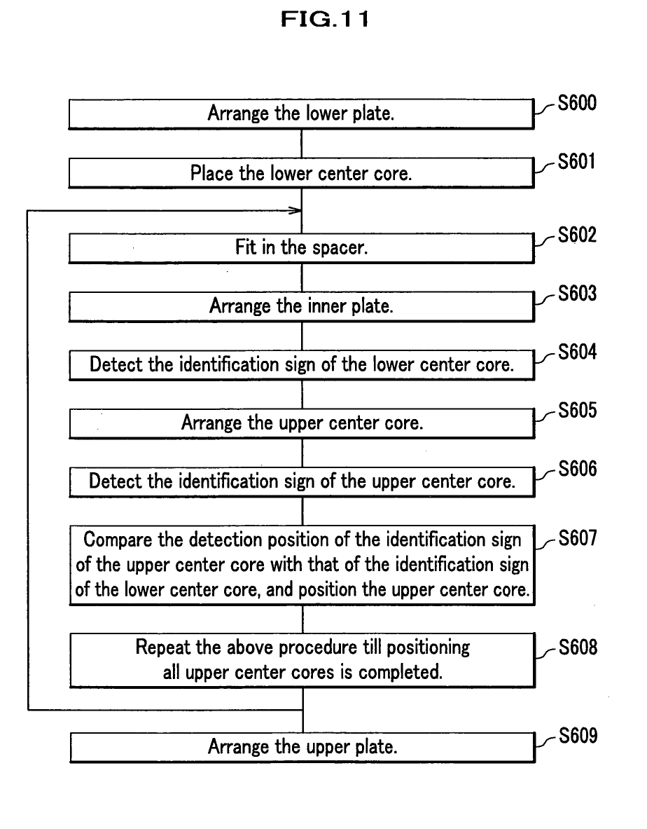

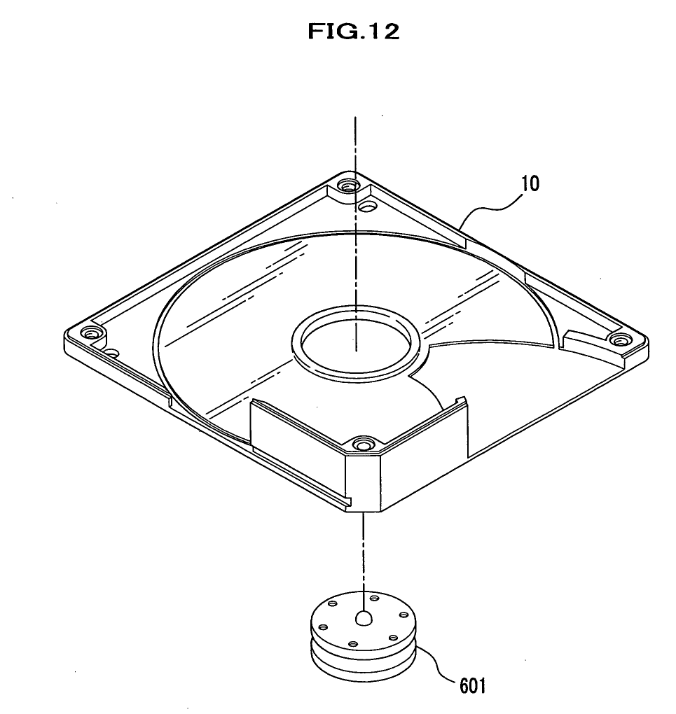

Using the assembling apparatus 100, an automatic processing in the assembling process S60 shown in FIG. 7 will be described, referring to FIGS. 11 and 12. Here will be mainly described operations of: the center core chucker 130, the spacer chucker 220, the assembling robot 600, the assembling spindle 601, and the position detector 602 controlled by the controlling unit 200; and the controlling unit 200.

FIG. 11 is a detailed procedure showing an automatic processing in the assembling process S60. Firstly, the assembling robot 600 grips the lower plate 10 supplied from the lower plate supply process S30 shown in FIG. 7 and arranges it on a predetermined work bench (S600). Meanwhile, on the lower plate 10 gripped are loaded the lower rotor 51, the shutter plate 51b, and the liner 49 shown in FIG. 1.

Subsequently, the center core chucker 130 positions the lower center core 42 held in the center core holding process S13 shown in FIG. 7 in a preset direction, and places it on a predetermined position (S601). According to this placement, the center core 42 results in being sucked to the assembling spindle 601 shown in FIG. 12. Next, the spacer chucker 220 holds the holding depressions 43e of the spacer 43 held in the spacer holding process S22 shown in FIG. 7, and fits the pins 43b of the spacer 43 protruded downward in the small holes 42e of the center core 42 placed in the S601 in a state of the spacer 43 being positioned in a preset direction (S602). Next, the assembling robot 600 arranges the inner plate 20 supplied from the inner plate supply process S40 shown in FIG. 7 so as to fit in the lower plate 10 arranged in the S600 (S603). Thereafter the position detector 602 detects the identification sign 42f of the lower center core 42 (S604).

Next, the center core chucker 130 arranges the upper center core 42 held in the center core holding process S13 at a central position of the inner plate 20 arranged in the S603, in a state of the upper center core 42 being positioned in a preset direction (S605). Subsequently, the position detector 602 detects the identification sign 42f of the upper center core 42 arranged in the S605 (S606). Then the controlling unit 200 compares a detection position of the identification sign 42f of the upper center core 42 detected in the S606 and that of the identification sign 42f of the lower center core 42 detected in the S604, and positions the upper center core 42 arranged in the S605 (S607). The positioning is performed, for example, by rotating the assembling spindle 601 shown in FIG. 12 and displacing a position of the lower center core 42 so that both detection positions match each other. Thus it is enabled to position the center core 42 more accurately. Meanwhile, if it is enabled to realize the positioning, it is not limited to a case that the both detection positions match each other, and it is also available to compensate the direction of the center core 42. Thus the controlling unit 200 performs control so as to repeat the processes from the S602 to the S607 till all upper center cores 42 are positioned (S608). Thus a plurality of center cores 42 result in being stacked. Then, when positioning all the upper center cores 42 is finished, the assembling robot 600 performs a predetermined assembling work (for example, an assembling work of the upper rotor 52 and the like shown in FIG. 1), and thereafter, finally arranges the upper plate 30 supplied from the upper plate supply process S50 shown in FIG. 7 on the uppermost inner plate 20 arranged in the S603 (S609). Thus the magnetic disk cartridge 1 shown in FIG. 1 is assembled.

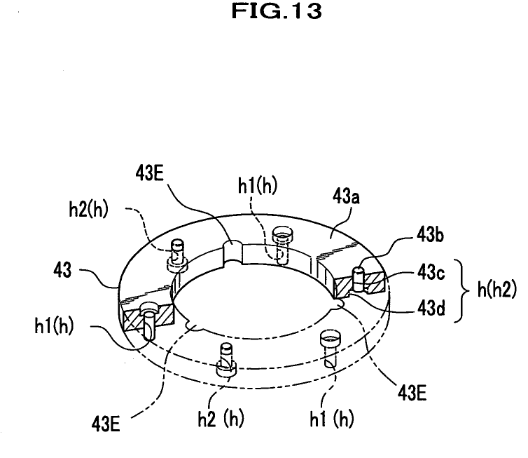

Thus, although the embodiment of the present invention is described, the invention can be embodied by varying it as needed without being limited thereto. For example, although in the embodiment the holding depressions 43e of the spacer 43 in FIG. 6 are shown, the embodiment may be another configuration as far as it does not depart from the spirit and scope of the invention. For example, holding depressions 43E shown in FIG. 13 are also available.

In addition, although in the embodiment the magnetic disk medium 41 is applied as a recording disk medium, the embodiment is also applicable to a case of an optical disk medium for recording data by light. Furthermore, although in the embodiment the lower plate 10, the inner plate 20, and the upper plate 30 are fastened and fixed by the screws 91, it is also enabled to integrally fix them by any of adhesion and welding.

In addition, the configuration of the assembling apparatus 100 and the order of production process (inclusive of an assembling process can be variously changed by known technologies. For example, although each of the center core chucker 130, spacer chucker 220, and assembling robot 600 of the assembling apparatus 100 is independently configured, these may be integrally configured.

What is claimed is:

1. A recording disk cartridge for integrally rotatably housing center cores, where a plurality of flexible recording disk media are fixed, within a cartridge case thereof through spacers, the cartridge case comprising:
a lower plate for configuring a lower wall parallel to the plurality of said recording disk media;
at least one inner plate that is stacked and fixed on said lower plate, and partitions the plurality of said recording disk media; and
an upper plate that is stacked and fixed on said inner plate, and configures an upper wall of said cartridge case,
wherein in each of said center cores are formed stop holes; and in each of said spacers are formed stop protrusions that can fit in said stop holes of said center cores, and holding depressions having a constant positional relationship with said stop protrusions.

2. A recording disk cartridge according to claim 1, wherein in each of said center cores is dispensed an identification sign for indicating positions of said stop holes.

3. A recording disk cartridge according to claim 2, wherein said identification sign is at least one of a notch, a depression, a protrusion, and a paint sign.

4. A recording disk cartridge according to claim 2, wherein said identification sign is dispensed on an extension line connecting a center of each of said center cores and stop holes of the center core.

5. A recording disk cartridge according to claim 1, wherein when stop protrusions of each of said spacers are fitted in stop holes of each of said center cores, holding depressions of the spacer are exposed.

6. A recording disk cartridge according to claim 1, wherein each of stop protrusions of said spacers is arranged at a predetermined distance from a rotation axis of the spacers, and each of holding depressions of the spacers corresponding to two of said stop protrusions is formed at peripheral rim of the spacers.

7. A recording disk cartridge according to claim 1, wherein stop protrusions of said spacers are alternately provided upward and downward, and each of holding depressions of the spacers are formed at peripheral rim of the spacers so as to be positioned at a midway point between said upward stop protrusion and said downward stop protrusion.

8. A recording disk cartridge according to claim 1, wherein each of stop protrusions of said spacers is arranged at a predetermined distance from a rotation axis of the spacers, and each of holding depressions of the spacers corresponding to two of said stop protrusions is formed at inner perimeter rim of the spacers.

9. A recording disk cartridge according to claim 1, wherein stop protrusions of said spacers are alternately provided upward and downward, and each of holding depressions of the spacers are formed at inner perimeter rim of the spacers so as to be positioned at middle of said upward stop protrusion and said downward stop protrusion.

10. An assembling method of a recording disk cartridge,
wherein said recording disk cartridge integrally rotatably houses said center cores, where a plurality of flexible recording disk media are fixed, within a cartridge case thereof through said spacers; wherein the cartridge case comprises a lower plate for configuring a lower wall parallel to the plurality of said recording disk media, at least one inner plate that is stacked and fixed on said lower plate and partitions the plurality of said recording disk media, and an upper plate that is stacked and fixed on said inner plate and configures an upper wall of said cartridge case; and wherein in each of said spacers are formed stop protrusions that can fit in stop holes each of said center cores, and holding depressions having a constant positional relationship with said stop protrusions, and in said center core is dispensed an identification sign for indicating positions of said stop holes,
wherein in stacking said center core where said recording disk media are fixed within said cartridge case, the assembling method comprising the processes of:
detecting said identification sign of said center core, and placing the center core in a constant direction; and
gripping holding depressions of said spacer by a chucker, and positioning and fitting stop protrusions to/in stop holes of said center core placed.

11. An assembling method of a recording disk cartridge according to claim 10 that compares detection positions of two identification signs of upper and lower center cores and compensates a direction of each of said upper and lower center cores, based on the detection positions compared, in stacking said upper center core on said lower center core.

12. An assembling apparatus of a recording disk cartridge,
wherein said recording disk cartridge integrally rotatably houses said center cores, where a plurality of flexible recording disk media are fixed, within a cartridge case thereof through said spacers; wherein the cartridge case comprises a lower plate for configuring a lower wall parallel to the plurality of said recording disk media, at least one inner plate that is stacked and fixed on said lower plate and partitions the plurality of said recording disk media, and an upper plate that is stacked and fixed on said inner plate and configures an upper wall of said cartridge case; and wherein in each of said spacers are formed stop protrusions that can fit in stop holes each of said center cores, and holding depressions having a constant positional relationship with said stop protrusions, and in said center core is dispensed an identification sign for indicating positions of said stop holes,
the assembling apparatus comprising:
an identification sign detector for detecting an identification sign of said center core where said recording disk media are fixed;
a center core chucker for placing said center core in a constant direction, based on the identification sign detected by said identification sign detector;
a spacer chucker for gripping holding depressions said spacer, and positioning and fitting said stop protrusions to/in stop holes of the center core placed by said center core chucker; and
an assembling robot for assembling said cartridge case for housing said center core stacked by said center core chucker and said spacer chucker.

13. An assembling apparatus of a recording disk cartridge according to claim 12 that compares detection positions of two identification signs of said upper center core and said lower center core, and further comprises a spindle that rotates any of said upper center core and said lower center core and positions said upper center core, based on the detection positions compared
